(19) United States
(12) Patent Application Publication
(10) Pub. No.: US 2026/0349818 A1
(43) Pub. Date: Nov. 5, 2026

(54) SYSTEMS AND METHODS FOR IDENTIFICATION OF IDLE SERVERS BY IMPLEMENTING MULTIDIMENSIONAL PROCESS AND NETWORK PROXIMITY METRICS

(71) Applicant: Fidelity Information Services, LLC, Jacksonville, FL (US)

(72) Inventor: Ranadhir GHOSH, St. Johns, FL (US)

(73) Assignee: Fidelity Information Services, LLC, Jacksonville, FL (US)

(21) Appl. No.: 19/662,904

(22) Filed: Apr. 29, 2026

Related U.S. Application Data
(60) Provisional application No. 63/797,169, filed on Apr. 30, 2025.

(51) Int. Cl. G06F 9/50

(52) U.S. Cl. CPC G06F 9/5027

(57) ABSTRACT

A computer implemented method for identifying an idle server is disclosed. The method includes receiving metric data from a server; determining, by a first machine learning system, a multidimensional embedding that defines a signature of the server, the multidimensional embedding being based on the metric data; applying, by a second machine learning system, a clustering algorithm to the multidimensional embedding to determine a first cluster from a set of clusters; determining, based on the first cluster, that the server is an idle server; and deactivating the idle server.

### RELATED APPLICATION

This application claims priority to U.S. Provisional Application No. 63/797,169, filed Apr. 30^{th}, 2025, which is hereby incorporated by reference in its entirety.

### TECHNICAL FIELD

Various embodiments of the present disclosure relate generally to identifying idle severing by applying machine learning techniques and, more particularly, to systems and methods for identification of idle servers by implementing multidimensional process and network proximity metrics.

### BACKGROUND

Idle servers, also referred to as zombie servers, may refer to computer servers that are running (e.g., in a data center) but are not performing useful and/or valuable computing. Idle servers may consume resources and time without contributing anything to productivity. Large systems may have a large number of servers and it may be challenging to accurately identify idle servers. The present disclosure is directed to addressing this and other drawbacks to the existing computing system incident analysis techniques.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a computer implemented method for identifying an idle server, the method including: receiving metric data from a server; determining, by a first machine learning system, a multidimensional embedding that defines a signature of the server, the multidimensional embedding being based on the metric data; applying, by a second machine learning system, a clustering algorithm to the multidimensional embedding to determine a first cluster from a set of clusters; determining, based on the first cluster, that the server is an idle server; and deactivating the idle server.

In some aspects, the techniques described herein relate to a method, wherein deactivating the idle server includes transmitting a deactivation command to the idle server over a network to cause the idle server to shut down, and reallocating computing resources previously assigned to the idle server to one or more active servers within a data center environment.

In some aspects, the techniques described herein relate to a method, further including: receiving communication data between the server and one or more additional servers, the communication data being based on traceroute data of the server; and defining a proximity score for the communication data, the proximity score being determined based upon the traceroute data, the proximity score defining a level of connection between the server and one or more additional servers.

In some aspects, the techniques described herein relate to a method, wherein the multidimensional embedding is further based on the proximity score.

In some aspects, the techniques described herein relate to a method, wherein the second machine learning system implements a random forest algorithm to determine the first cluster from the set of clusters.

In some aspects, the techniques described herein relate to a method, wherein the clustering algorithm compares a distance of the multidimensional embedding with a set of multidimensional embeddings associated with the set of clusters.

In some aspects, the techniques described herein relate to a method, further including: upon determining the server is an idle server, updating a database to indicate that the server is a zombie server; and transmitting an alert to a network management system identifying the idle server for removal from an active server pool.

In some aspects, the techniques described herein relate to a system for identifying an idle server, the system including: a memory having processor-readable instructions stored therein; and at least one processor configured to access the memory and execute the processor-readable instructions to perform operations including: receiving metric data from a server; determining, by a first machine learning system, a multidimensional embedding that defines a signature of the server, the multidimensional embedding being based on the metric data; applying, by a second machine learning system, a clustering algorithm to the multidimensional embedding to determine a first cluster from a set of clusters; determining, based on the first cluster, that the server is an idle server; and deactivating the idle server.

In some aspects, the techniques described herein relate to a system, wherein deactivating the idle server includes transmitting a deactivation command to the idle server over a network to cause the idle server to shut down, and reallocating computing resources previously assigned to the idle server to one or more active servers within a data center environment.

In some aspects, the techniques described herein relate to a system, further including: receiving communication data between the server and one or more additional servers, the communication data being based on traceroute data of the server; and defining a proximity score for the communication data, the proximity score being determined based upon the traceroute data, the proximity score defining a level of connection between the server and one or more additional servers.

In some aspects, the techniques described herein relate to a system, wherein the multidimensional embedding is further based on the proximity score.

In some aspects, the techniques described herein relate to a system, wherein the second machine learning system implements a random forest algorithm to determine the first cluster from the set of clusters.

In some aspects, the techniques described herein relate to a system, wherein the clustering algorithm compares a distance of the multidimensional embedding with a set of multidimensional embeddings associated with the set of clusters.

In some aspects, the techniques described herein relate to a system, further including: upon determining the server is an idle server, updating a database to indicate that the server is a zombie server; and transmitting an alert to a network management system identifying the idle server for removal from an active server pool.

In some aspects, the techniques described herein relate to a non-transitory computer readable medium storing processor-readable instructions which, when executed by at least one processor, cause the at least one processor to perform operations including: receiving metric data from a server; determining, by a first machine learning system, a multidimensional embedding that defines a signature of the server, the multidimensional embedding being based on the metric data; applying, by a second machine learning system, a clustering algorithm to the multidimensional embedding to determine a first cluster from a set of clusters; determining, based on the first cluster, that the server is an idle server; and deactivating the idle server.

In some aspects, the techniques described herein relate to a non-transitory computer readable medium, wherein deactivating the idle server includes transmitting a deactivation command to the idle server over a network to cause the idle server to shut down, and reallocating computing resources previously assigned to the idle server to one or more active servers within a data center environment.

In some aspects, the techniques described herein relate to a non-transitory computer readable medium, further including: receiving communication data between the server and one or more additional servers, the communication data being based on traceroute data of the server; and defining a proximity score for the communication data, the proximity score being determined based upon the traceroute data, the proximity score defining a level of connection between the server and one or more additional servers.

In some aspects, the techniques described herein relate to a non-transitory computer readable medium, wherein the multidimensional embedding is further based on the proximity score.

In some aspects, the techniques described herein relate to a non-transitory computer readable medium, wherein the second machine learning system implements a random forest algorithm to determine the first cluster from the set of clusters.

In some aspects, the techniques described herein relate to a non-transitory computer readable medium, wherein the clustering algorithm compares a distance of the multidimensional embedding with a set of multidimensional embeddings associated with the set of clusters.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. As will be apparent from the embodiments below, an advantage to the disclosed systems and methods is that multiple parties may fully utilize their data without allowing others to have direct access to raw data. The disclosed systems and methods discussed below may allow advertisers to understand users' online behaviors through the indirect use of raw data and may maintain privacy of the users and the data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A depicts a block diagram for an exemplary environment for identifying idle servers, according to one or more embodiments.

FIG. 1B depicts exemplary modules within an exemplary computing device, according to one or more embodiments.

FIG. 1C depicts exemplary configuration files of a metric data collection module, according to one or more embodiments.

FIG. 1D depicts exemplary modules within an AI module, according to one or more embodiments.

FIG. 2 depicts a flowchart of training a system to identify idle servers, according to one or more embodiments.

FIG. 3 depicts a flowchart of an exemplary method for identifying an idle server, according to one or more embodiments.

FIG. 4 illustrates a computer system for executing the techniques described herein, according to one or more embodiments of the present disclosure.

### DETAILED DESCRIPTION OF EMBODIMENTS

Various embodiments of the present disclosure relate generally to identifying idle severing by applying machine learning techniques and, more particularly, to systems and methods for identification of idle servers by implementing multidimensional process and network proximity metrics.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

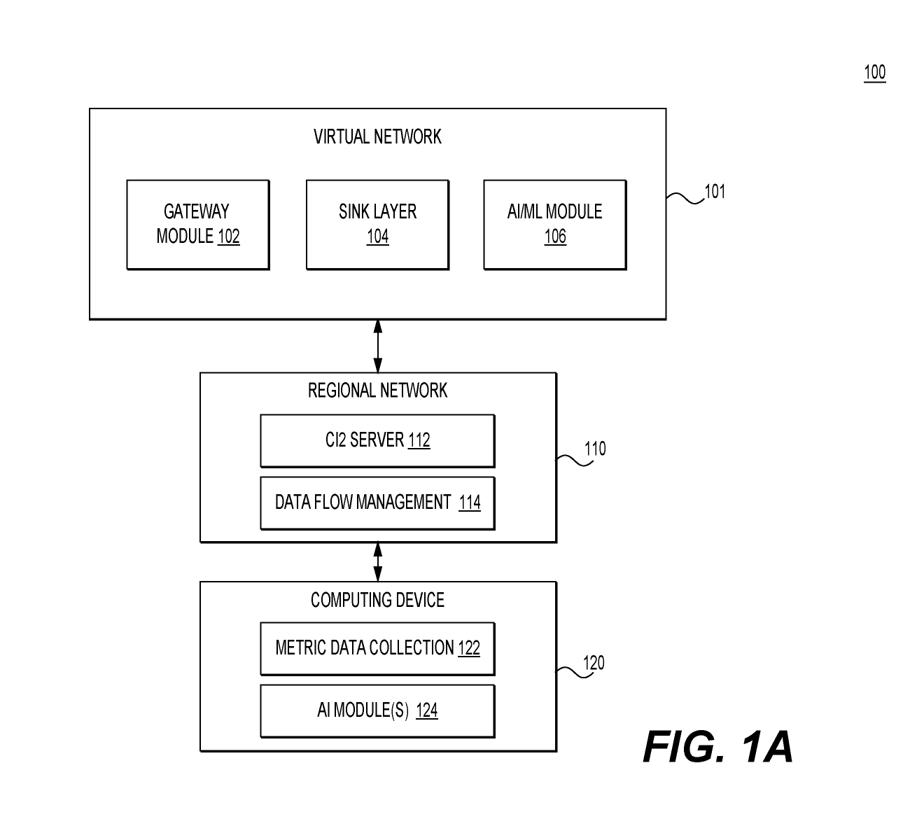

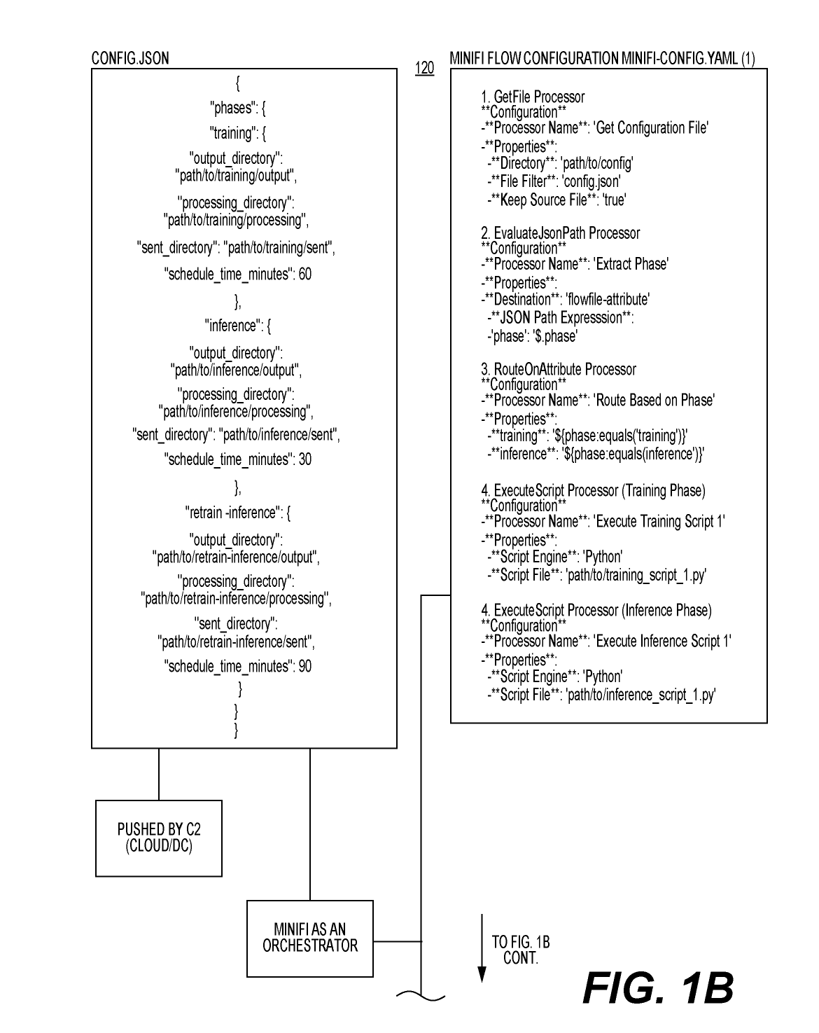

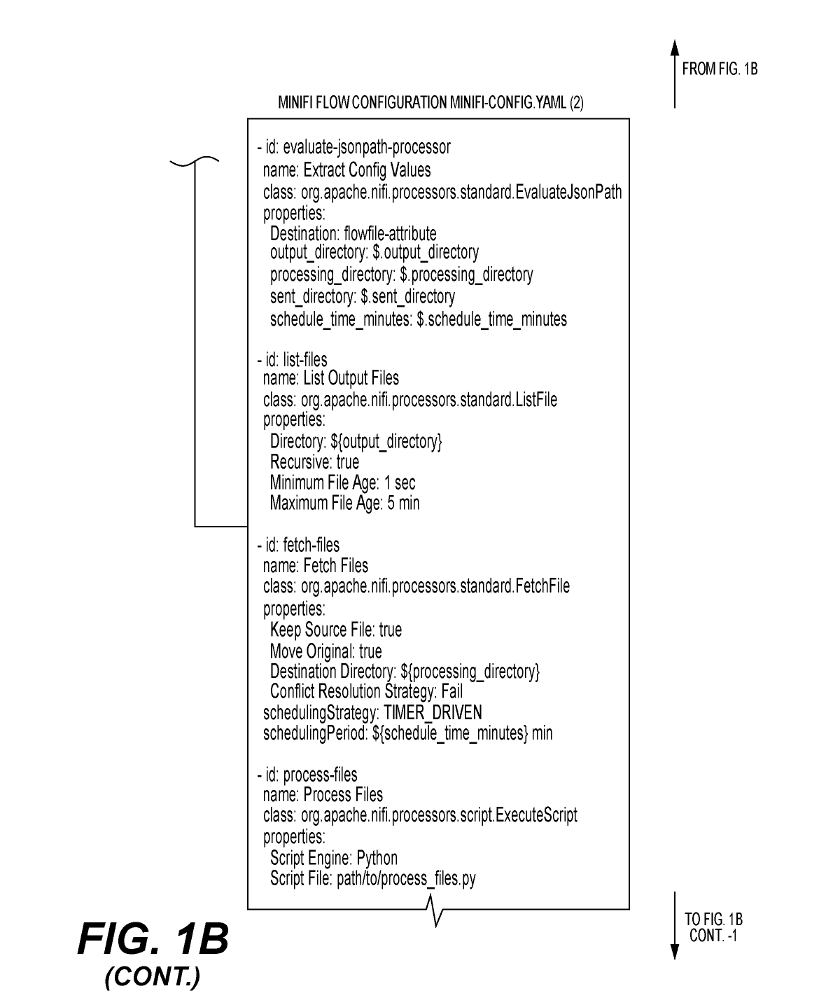

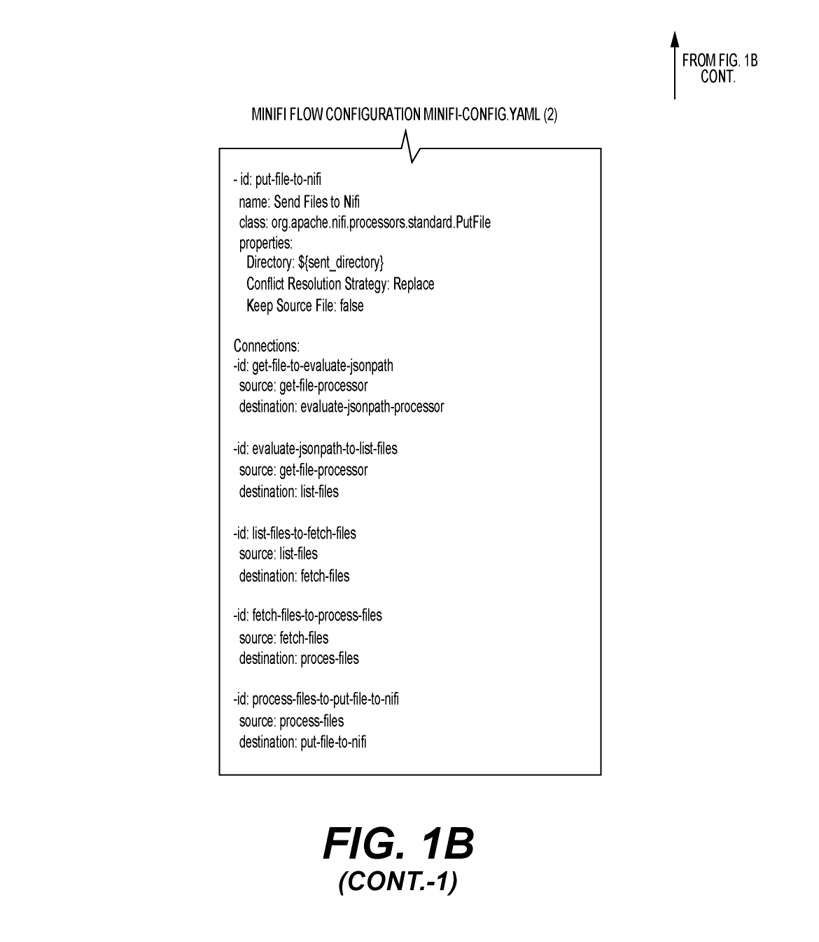

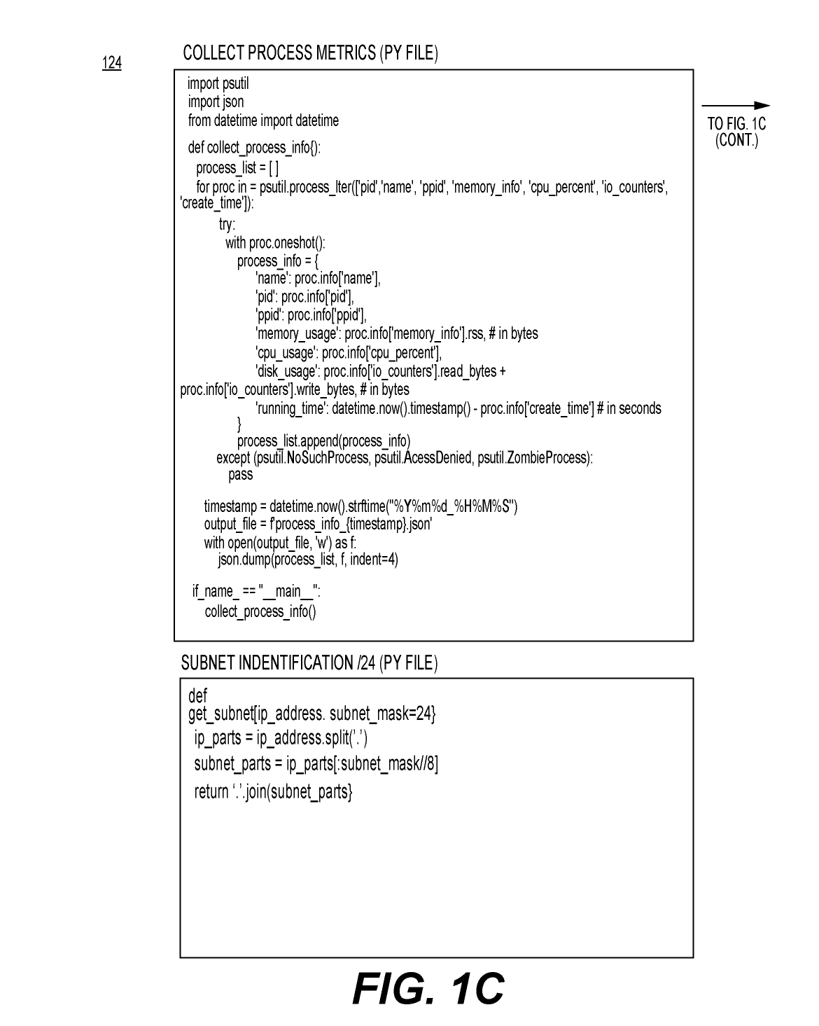

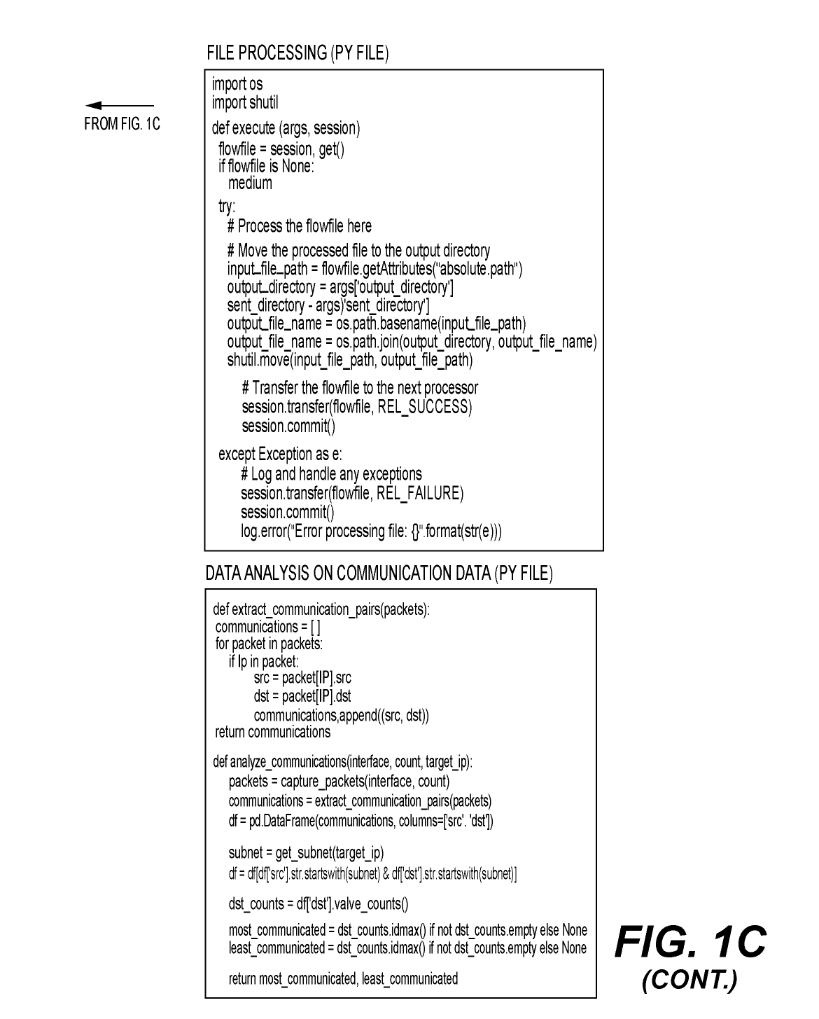

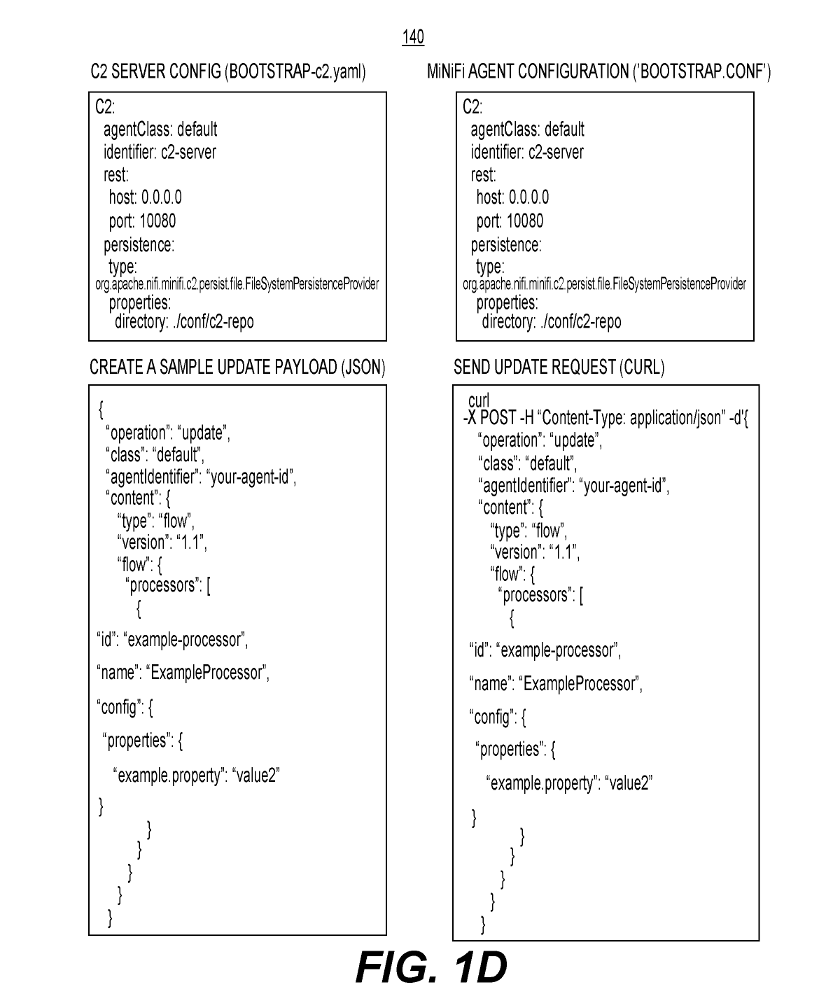

Any suitable system infrastructure may be put into place to allow user control of an interactive audiovisual environment, and engagement assessment. FIG. 1A and the following discussion provide a brief, general description of a suitable computing environment in which the present disclosure may be implemented. In one embodiment, any of the disclosed systems, methods, and/or graphical user interfaces may be executed by or implemented by a computing system consistent with or similar to that depicted in FIG. 1A. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Idle servers, also referred to as zombie servers, may refer to computing servers that are running or being implemented in a system (e.g., at a data center) but not performing useful computational tasks. These servers consume substantial computing resources including electrical power, cooling capacity, network bandwidth, and physical rack space without contributing productive work to the data center operations. An idle server may refer to a server performing processing below a predetermined threshold value over an extended period. The technical challenge of identifying such servers is compounded by the dynamic nature of modern computing workloads, where servers may legitimately experience periods of low utilization followed by high-demand processing cycles.

Studies have estimated that approximately 30% of all servers in data centers may be classified as zombie servers, resulting in billions of dollars in wasted energy costs globally. The technical problem extends beyond mere energy waste to include inefficient allocation of computational resources, degraded network performance due to unnecessary traffic from idle systems, and increased complexity in data center management. Conventional approaches to identifying idle servers rely on static threshold-based rules that compare instantaneous or short-term averaged metrics against predetermined values. However, these static threshold approaches suffer from significant technical deficiencies: for example, they cannot distinguish between a truly idle server and a server experiencing temporary low utilization during normal operational cycles, they fail to account for the contextual relationship between a server and its network neighbors, and they generate excessive false positives that burden system administrators with manual verification tasks.

The technical limitations of conventional idle server detection are particularly acute at scale. Large data centers may contain hundreds of thousands of servers with heterogeneous workload patterns, making manual inspection impractical and static rules inadequate. Servers may have fluctuating workloads based on time-of-day patterns, batch processing schedules, or event-driven architectures that cause legitimate periods of low activity. Furthermore, conventional systems may lack the ability to incorporate network topology and communication patterns into their analysis, missing critical contextual information about whether a server is genuinely disconnected from productive work or merely awaiting incoming requests from dependent systems.

Existing rule-based detection systems may also fail to adapt to evolving data center configurations and changing workload characteristics. As applications are deployed, modified, or decommissioned, the baseline behavior of servers changes in ways that static thresholds cannot accommodate. This results in either overly aggressive detection that incorrectly flags active servers or overly permissive detection that allows zombie servers to persist undetected. The inability of conventional systems to learn from historical patterns and adapt to new operational contexts represents a fundamental technical barrier to effective idle server management.

Embodiments of the disclosed system may address these technical deficiencies by implementing a machine learning-based approach that generates multidimensional embeddings from server metrics to create signature patterns that characterize server behavior holistically rather than through isolated threshold comparisons. By converting process metrics including memory utilization, CPU usage, disk activity, and network traffic into key performance indicator vectors, the system captures the complex interrelationships between different resource utilization dimensions that distinguish idle servers from temporarily quiescent but operationally active servers. This embedding-based approach enables the system to identify subtle patterns in server behavior that would be invisible to conventional threshold-based detection.

The system may further improve upon conventional approaches by incorporating proximity metrics derived from traceroute data to establish network context for each server. By analyzing communication patterns between servers, the system can determine whether a low-utilization server is isolated from productive network activity or maintains active connections with other systems that indicate ongoing operational relevance. This dual-metric approach combining process metrics with proximity metrics provides a more complete technical characterization of server state than either metric type alone, reducing false positive detections and improving the accuracy of idle server identification.

The clustering algorithm applied to the multidimensional embeddings may create signature patterns for groups of servers with similar behavioral characteristics, enabling the system to classify new server observations against established patterns rather than arbitrary thresholds. This clustering approach provides technical advantages including the ability to identify previously unknown categories of idle server behavior, adaptation to heterogeneous server populations with different baseline characteristics, and scalability to large data center environments where manual pattern definition would be impractical.

The supervised learning component of the system may learn to differentiate between positive samples representing idle servers and negative samples representing active servers by establishing maximum boundary separation in the embedding space. This learning-based approach ensures that the signature patterns adapt dynamically to changing data center conditions rather than relying on static rules that degrade in accuracy over time. The system's ability to incorporate feedback and retrain on new observations provides continuous improvement in detection accuracy and enables adaptation to evolving workload patterns without manual reconfiguration.

One or more embodiments may include a first machine learning system configured to generate multidimensional embeddings from collected metric data, wherein the embeddings encode server behavior as vectors in a high-dimensional space that captures correlations between memory, CPU, disk, and network utilization patterns. The first machine learning system may implement transformer-based architectures such as Bidirectional Encoder Representation from Transformers (“BERT”), to generate contextualized embeddings that account for temporal patterns in server metrics.

One or more embodiments may include a second machine learning system implementing a random forest classifier trained on labeled cluster data to determine whether a server's embedding corresponds to an idle server cluster or an active server cluster. The random forest algorithm provides technical advantages including robustness to noisy input data, interpretability of feature importance for diagnostic purposes, and efficient inference suitable for real-time classification of server states.

One or more embodiments may include a proximity score calculation module that processes traceroute data to quantify the network distance and communication frequency between a target server and other servers in the environment. The proximity score provides a technical measure of server connectivity that distinguishes isolated idle servers from servers that maintain active network relationships despite low local resource utilization.

One or more embodiments may include region-specific cluster definitions that account for different server populations and workload characteristics across geographic or logical network regions. By maintaining separate cluster models for each region, the system provides improved classification accuracy for heterogeneous data center environments where server behavior patterns vary based on regional application deployments and operational requirements.

One or more embodiments may provide an improvement to data center management technology by enabling automated identification and deactivation of idle servers based on learned signature patterns rather than static rules, thereby reducing energy consumption and improving resource utilization across the data center environment.

FIG. 1A depicts a block diagram for an exemplary environment 100 for identifying idle servers, according to one or more embodiments. Environment 100 includes a virtual network 101, a regional network 110, and a computing device 120 (e.g., one or more computing devices, a plurality of computing devices,) that may be connected within the virtual network 101. In some examples, the virtual network 101 may be connected to one or more regional networks 110, and each regional network 110 may be connected to one or more computing devices 120. The environment 100 establishes a hierarchical architecture that enables scalable collection of metric data from distributed computing resources while centralizing the machine learning-based analysis for idle server identification. This hierarchical structure allows the system to process metric data from thousands or hundreds of thousands of servers across multiple geographic regions while maintaining efficient data flow and computational resource allocation.

The virtual network 101 may be connected to the regional network 110 and the computing device 120 may be connected by a network that may be of any suitable type, including individual connections via the Internet, such as cellular or Wi-Fi networks. In some aspects, network may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security. The network architecture supports bidirectional communication to enable both the collection of metric data from computing devices and the transmission of control commands for deactivating identified idle servers.

The virtual network 101 may include any type of computer networking arrangement used to exchange data or information. For example, the network may be the Internet, a private data network, virtual private network using a public network and/or other suitable connection(s) that enables components in environment 100 to send and receive information between the components of virtual network 101, regional network 110, and/or computing device 120. The virtual network 101 serves as the central coordination layer for the idle server identification system, aggregating data from multiple regional networks and providing centralized machine learning inference capabilities.

The virtual network 101 may include a gateway module 102, a sink layer 104, and an AI/ML module 106. The gateway module 102 may be configured to act as an entry/exit point for network traffic between virtual network 101 and the regional network 110. The gateway module 102 may, for example, incorporate a Virtual Private Network (“VPN”) gateway, a Network Address Translations (“Nat”) Gateway, an internet gateway, and/or an application gateway. The gateway module 102 may implement traffic filtering and load balancing to manage the volume of metric data received from multiple regional networks 110. The sink layer 104 may include one or more servers configured to collect, process, and/or store data received from the regional network 110. This may include saving lists of identified idle servers and identified clusters by particular regional networks as discussed below. The sink layer 104 may implement a distributed storage architecture to handle the high volume of metric data and embedding vectors generated during the idle server identification process. The sink layer 104 may further include a vector database configured to store multidimensional embeddings and support efficient similarity searches for cluster assignment. The AI/ML module 106 may be configured to analyze process metrics and proximity metrics of servers to identify idle servers. The AI/ML module 106 may incorporate one or more machine learning models such as a random forest classifier. The AI/ML module 106 may include both training and inference pipelines, enabling the system to continuously improve its idle server detection accuracy based on new data and feedback.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

The regional network 110 may include a CI2 server 112 and a data flow management module 114. The CI2 server 112 and data flow management module 114 may be configured to retrieve data from the computing device 120 and to store data from the computing device 120. These modules may further assist with transferring data to the virtual network 101. The CI2 server 112 may function as a command and control server that manages configuration updates and operational parameters for the computing devices 120 within its region. The CI2 server 112 may push configuration files to computing devices 120 to specify data collection schedules, processing parameters, and inference settings. The data flow management module 114 may implement data pipeline orchestration to ensure reliable and efficient transfer of metric data from computing devices 120 to the sink layer 104 of the virtual network 101. The data flow management module 114 may implement buffering, compression, and batching techniques to optimize network bandwidth utilization during data transfer operations.

The computing device 120 may include metric data collection software 122 and AI module(s) 124. FIG. 1B depicts these exemplary modules and how they may be configured to interact with the CI2 server 112. The metric data collection software 122 may be configured to collect, process, and transmit data from the computing device 120 to a more central data system (e.g., the regional network 110). The metric data collection software 122 may allow for ingestion and processing of process data such as memory, CPU, disks and network data of the computing device 120. The metric data collection software 122 may further collect device proximity data defining network distance to other systems, devices, servers, or users. In some examples, the proximity data may be determined based on traceroute data tracking interactions of the computer with other servers, routers, and/or network devices. In some examples, the metric data collection software 122 may be MiniNiFi software. MiniNiFi may refer to a lightweight data flow management agent that enables edge-based data collection and processing with minimal resource overhead on the computing device 120. The MiniNiFi software may be configured through YAML configuration files that define processor chains for data collection, transformation, and transmission operations. FIG. 1B illustrates exemplary configuration files including a CONFIG.JSON file that specifies phase definitions for training, inference, and retrain-inference operations, each with associated directory paths and schedule timing parameters. The MiniNiFi flow configuration file may define processor components including GetFile processors for retrieving configuration data, EvaluateJsonPath processors for extracting configuration parameters, RouteOnAttribute processors for directing data flow based on operational phase, and ExecuteScript processors for executing Python scripts that perform data collection and processing operations. In some examples, FIG. 1D may display modules 140 including a MiniNiFi software and one or more modules for communicating data from within the computing device with the CI2 server 112 of the regional network 110. For example, these modules may illustrate how to configure a particular computing system to interact with the CI2 server of the regional network 110. The modules 140 may include bootstrap configuration files that specify agent class identifiers, REST API endpoints for communication with the CI2 server 112, and persistence settings for maintaining state across system restarts. The modules 140 may further include sample update payloads in JSON format that demonstrate how the CI2 server 112 transmits configuration updates to computing devices 120, including flow type specifications, version information, and processor configuration parameters.

The AI module(s) 124 may include one or more machine learning models configured to generate embeddings of the retrieved data from the metric data collection software 122 and to perform clustering algorithms on the generated embeddings. For example, the AI module(s) 124 may include a transformer model such as a BERT configured to generate contextualized word embeddings. The AI module(s) 124 may process the collected metric data to generate key performance indicator vectors that encode the multidimensional characteristics of server behavior. FIG. 1C displays the AI module(s) 124 displaying the processes for collecting metric data and applying the AI module(s) 124. FIG. 1C illustrates exemplary Python code modules that implement the data collection and analysis functionality of the AI module(s) 124. A first code module labeled COLLECT PROCESS METRICS may implement a function that iterates through running processes to gather metrics including process name, process identifier, parent process identifier, memory usage, CPU usage, disk usage, and running time, then serializes the collected data to a JSON file with a timestamp for subsequent processing. A second code module labeled SUBNET IDENTIFICATION may implement a function that extracts subnet information from IP addresses to support proximity score calculations based on network topology. Additional code modules may implement file processing operations for managing data flow between collection and analysis stages, and communication data analysis functions that extract communication pairs from network packets, create data structures for analyzing source and destination relationships, and identify most and least communicated destinations to support the proximity metric calculations used in idle server identification. The AI module(s) 124 may operate in multiple phases including a training phase where embeddings are generated and clusters are established, an inference phase where new server data is classified against established clusters, and a retrain-inference phase where the models are updated based on new data while continuing to perform classification operations.

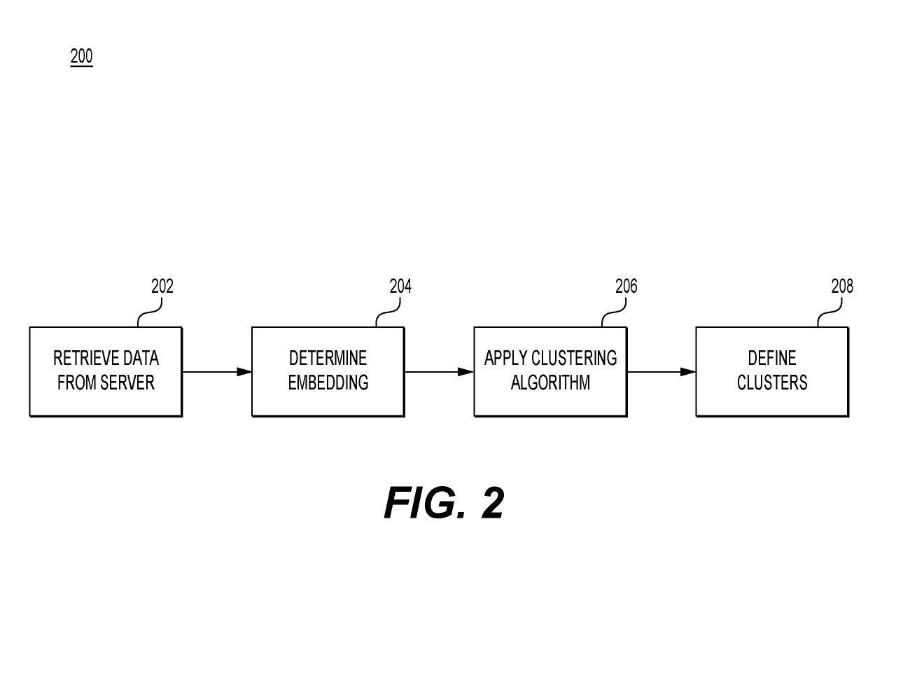

FIG. 2 depicts a flowchart of a method 200 for training a system to identify idle servers, according to one or more embodiments. The method 200 may, for example, be implemented by environment 100 of FIG. 1A. The method of FIG. 2 may be utilized to train the AI/ML module 106 of FIG. 1A. For example, FIG. 2 may provide an exemplary method for training the machine learning model to identify clusters of computing devices that may have idle servers. The method of FIG. 2 may be utilized to train the machine learning model based on computer metrics. The training process establishes baseline behavioral patterns for servers across the data center environment, enabling the system to distinguish between servers exhibiting idle characteristics and servers performing productive computational work. The method 200 may be executed periodically to update the trained model with new data reflecting changes in data center configurations and workload patterns.

At step 202, the system (e.g., virtual network 101) may retrieve data from one or more computing devices (e.g., computing device 120). This data may include information such as memory, CPU, disks and network data, and running time data. CPU data may refer to the percentage of CPU usage over time can be broken down by core. Memory data may refer to the amount of memory used versus total availably memory. Disk data may refer to disk space used and available on different partitions. Network data may refer to the incoming and outgoing network traffic. The retrieved data may collectively be referred to as metric data. The retrieval process may be performed by the metric data collection software 122 executing on each computing device 120, which may utilize lightweight data collection agents such as MiniNiFi to gather metrics with minimal impact on server performance. The metric data collection software 122 may be configured through YAML configuration files that specify collection intervals, data formats, and transmission schedules. The system may retrieve data at configurable intervals, such as every 30 seconds, 1 minute, or 5 minutes, depending on the granularity required for accurate idle server detection. The retrieved data may be timestamped and associated with unique server identifiers to enable tracking of individual server behavior over time. The data flow management module 114 of the regional network 110 may aggregate metric data from multiple computing devices 120 within its region before transmitting the aggregated data to the sink layer 104 of the virtual network 101 for centralized processing.

At step 204, the retrieved data may be converted into key performance indicator (KPI) embedding (e.g., vectors). This may include converting the retrieved data into KPI data values. KPIs may be metrics meant to measure the performance, utilization, and efficiency of the retrieved data. For example, KPI's for CPU data may include CPU utilization percentage, CPU load average, CPU idle time, etc. Upon determining KPI data for the retrieved data, the data may then be stored as an embedding (e.g., as a vector). The conversion process may involve normalizing the raw metric values to a common scale, such as a range between 0 and 1, to ensure that different metric types contribute proportionally to the embedding representation. The system may apply statistical transformations to the metric data, including calculating rolling averages, standard deviations, and percentile values over configurable time windows to capture temporal patterns in server behavior. The embedding generation process may concatenate multiple KPI values into a single multidimensional vector, where each dimension corresponds to a specific metric or derived statistic. For example, an embedding vector may include dimensions for average CPU utilization, peak CPU utilization, memory utilization variance, disk I/O rate, network packet count, and process count, resulting in a vector with tens or hundreds of dimensions that comprehensively characterizes server behavior.

In some examples, the KPI embeddings may be determined by a first machine learning system (e.g., AI module(s) 124 of FIG. 1A). In an example, the signature embedding may be determined by implementing BERT. The embeddings may be saved an index (e.g., within environment 100). The index may be a vector database and may be configured to employ techniques such as quantization, indexing, and efficient distance computation to store and process large-scale datasets. The index may be configured to use vector representation of data points and to perform approximate nearest neighbor searches to find similar vectors. The index may, for example, be the "Facebook AI Similarity Search" (FAISS) library. The BERT-based embedding generation may process sequences of metric values as input tokens, applying self-attention mechanisms to capture relationships between different metric types and temporal dependencies within the data. The transformer architecture may generate contextualized embeddings that encode not only the individual metric values but also the correlations and patterns among metrics that characterize specific server operational states. The vector database may implement hierarchical navigable small world (HNSW) graphs or inverted file indices to enable efficient similarity searches across millions of stored embeddings. The system may partition the vector space into cells or clusters to accelerate nearest neighbor queries, reducing search complexity from linear to logarithmic or sub-linear time.

For example, steps 202 and 204 may be performed on a set of servers to within an environment. For example, these may be performed thousands to hundreds of thousands times to generate a set of vectors to utilize for training. The system may collect metric data from servers over an extended period, such as days or weeks, to capture diverse operational patterns including peak usage periods, maintenance windows, and idle periods. The training dataset may include metric data from servers with known operational states, including servers that have been manually identified as idle by system administrators, to provide ground truth labels for supervised learning components of the training process. The system may implement data augmentation techniques to increase the diversity of the training dataset, such as adding noise to metric values or interpolating between existing data points to generate synthetic training examples.

At step 206, a clustering algorithm may be applied to the vectors from step 204 to associate each embedding with a particular cluster. For example, K-means clustering may be applied to partition embeddings into k clusters by minimizing the variance within each vector. Upon the completion of step 206, each determined vector may have an associated cluster. In some examples, there may be three to five thousands clusters determined. The K-means algorithm may initialize cluster centroids using techniques such as K-means++ initialization, which selects initial centroids that are well-distributed across the embedding space to improve convergence speed and clustering quality. The algorithm may iteratively assign each embedding to the nearest centroid based on Euclidean distance or cosine similarity, then update centroid positions based on the mean of assigned embeddings until convergence criteria are satisfied. The system may determine the optimal number of clusters using techniques such as the elbow method, silhouette analysis, or gap statistic, which evaluate clustering quality across different values of k to identify the number of clusters that best captures the natural structure of the data. Alternative clustering algorithms such as DBSCAN, hierarchical clustering, or Gaussian mixture models may be employed depending on the characteristics of the embedding distribution and the desired cluster properties. The clustering process may be performed separately for different server types, application categories, or geographic regions to account for heterogeneous baseline behaviors across the data center environment.

At step 208, each cluster may be defined as either an idle or a non-idle cluster. For example, certain clusters may have been previously defined as idle (e.g., through manual input or through an algorithm). Clusters that include a majority of idle servers may be identified as clusters associated with idle servers. The clusters may then be labeled as training data. This labeled cluster data may then be utilized to train a machine learning model (e.g., AI/ML module 106) to identify clusters associated with idle serves. For example, the machine learning model may be a primary classification model such as a random forest machine learning model. The cluster labeling process may involve analyzing the characteristics of servers within each cluster, including their historical utilization patterns, network activity levels, and application deployment status. The system may apply heuristic rules to initially label clusters, such as identifying clusters where the average CPU utilization is below a threshold value (e.g., 5%) and network traffic is minimal over an extended period. Human operators may review and validate the cluster labels through a user interface that displays cluster statistics and representative server examples, enabling correction of mislabeled clusters before training. The random forest classifier may be trained using the labeled cluster data as input features and the idle/non-idle labels as target outputs, learning decision boundaries that separate idle server clusters from active server clusters in the embedding space. The training process may employ cross-validation techniques to evaluate model performance and prevent overfitting, splitting the labeled data into training and validation sets to assess classification accuracy on held-out examples. The trained model may output probability scores indicating the likelihood that a given embedding belongs to an idle server cluster, enabling configurable decision thresholds for different operational requirements.

In some examples, the clusters determined from the method of FIG. 2 may related to a specific regional network 110 of environment 100. For example, the method of FIG. 2 may be applied to each region in environment 100. This may allow for each region to have its own set of clusters. This may account for different regions having servers with different functions and may allow for more accurate assignment of idle servers. The region-specific clustering approach recognizes that servers in different geographic locations or logical network segments may exhibit different baseline behaviors due to variations in deployed applications, user traffic patterns, and operational schedules. For example, servers in a region primarily hosting batch processing workloads may exhibit periodic high utilization followed by extended idle periods, while servers in a region hosting web applications may exhibit more consistent utilization patterns. The system may maintain separate cluster models and trained classifiers for each region, enabling region-specific idle server detection that accounts for local operational characteristics. The regional models may be periodically synchronized and compared to identify global patterns that apply across regions while preserving region-specific adaptations.

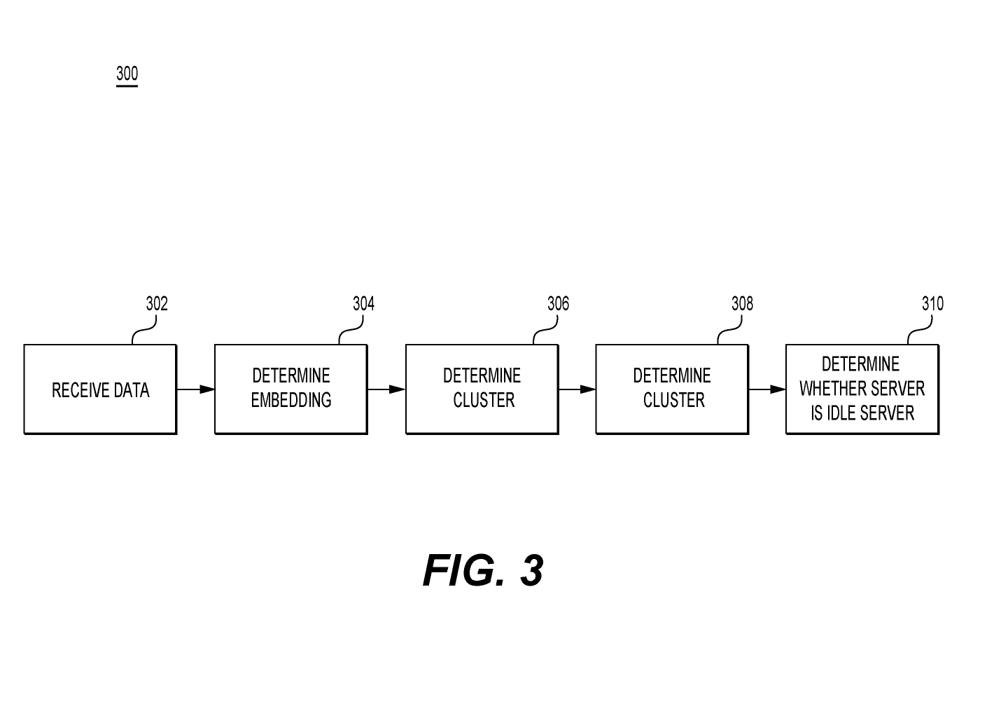

FIG. 3 depicts a flowchart of an exemplary method for identifying an idle server, according to one or more embodiments. The method 300 may, for example, be implemented by environment 100 of FIG. 1A. The method of FIG. 3 may be utilized identify idle servers within an environment of interconnected servers. The method may identify idle servers based on process metrics and proximity metrics. The method 300 represents the inference phase of the idle server identification system, applying the trained models from method 200 to classify new server observations in real-time or near-real-time. The method 300 may be executed continuously or at scheduled intervals to monitor the operational state of servers across the data center environment and identify servers that have transitioned to an idle state.

At step 302, metric data may be retrieved from a server (e.g., computing device 120). This metric data may include memory usage data, central processing unit usage data, disk usage data, and running time data. This may further include receiving communication data between the server and one or more additional servers, the communication data being based on traceroute data of the server. The metric data retrieval at step 302 may utilize the same data collection infrastructure established during the training phase, with the metric data collection software 122 gathering current operational metrics from the target server. The system may retrieve metric data covering a configurable time window, such as the most recent 15 minutes, 1 hour, or 24 hours, to capture sufficient temporal context for accurate classification. The traceroute data may be collected by executing traceroute commands from the target server to other servers in the environment, recording the network path and hop count between servers. The communication data may include packet capture information identifying the source and destination IP addresses of network traffic, enabling analysis of the server's communication patterns with other systems. The system may filter the communication data to focus on relevant traffic types, such as application-layer protocols or specific port ranges, while excluding routine infrastructure traffic such as DNS queries or health check probes.

At step 304, a multidimensional embedding may be determined by a first machine learning system (e.g., by AI module(s) 124) based on the metric data from step 302, where the multidimensional embedding defines a signature of the server. For example, the techniques described in step 204 may be applied to determine an embedding of the metric data. The embedding generation process at step 304 applies the same transformation pipeline used during training to ensure consistency between training and inference embeddings. The first machine learning system may load pre-trained model weights and apply them to the input metric data to generate the multidimensional embedding vector. The embedding may capture the current operational signature of the server, encoding the relationships between different metric types and temporal patterns observed in the collected data. The system may apply feature scaling using statistics computed during training, such as mean and standard deviation values, to normalize the input data before embedding generation. The resulting embedding vector may be stored temporarily for use in subsequent classification steps and may also be persisted to the vector database for future reference and model retraining purposes.

At step 306, a second machine learning system (e.g., the AI/ML module 106) may be applied to the multidimensional embedding to determine a first cluster from a set of clusters associated with the server. The second machine learning system may implement a random forest algorithm. This may include applying a clustering algorithm such as k-means nearest algorithm to the server. This may include comparing distance of the multidimensional embedding with a set of multidimensional embeddings associated with the set of clusters. The cluster assignment process at step 306 may involve computing the distance between the server's embedding and the centroids of all established clusters, selecting the cluster with the minimum distance as the assigned cluster. The distance computation may use Euclidean distance, cosine similarity, or other distance metrics appropriate for the embedding space. The random forest classifier may receive the embedding vector as input and output a classification decision along with a confidence score indicating the probability that the server belongs to an idle server cluster. The classifier may evaluate multiple decision trees in parallel, with each tree making an independent classification decision based on different subsets of the embedding dimensions, and the final classification may be determined by majority voting across all trees. The system may apply a confidence threshold to the classification output, requiring a minimum probability score (e.g., 0.8 or 80%) before classifying a server as idle to reduce false positive detections. The cluster assignment may also consider the proximity score derived from traceroute data, incorporating network connectivity information into the classification decision to distinguish between isolated idle servers and servers that maintain active network relationships.

The method may further include defining a proximity score for the communication data, the proximity score being determined based upon the traceroute data. The proximity score may define a level of connection between the server and one or more additional servers. The proximity score calculation may analyze the traceroute data to determine the network distance between the target server and other servers in the environment, measured in terms of hop count, latency, or network topology position. The system may compute a weighted sum of communication frequencies with other servers, where servers that are frequently communicated with contribute more to the proximity score than servers with infrequent communication. The proximity score may be normalized to a range between 0 and 1, where a score near 0 indicates an isolated server with minimal network connectivity and a score near 1 indicates a highly connected server with active communication relationships. The system may identify the most frequently communicated destinations and the least frequently communicated destinations to characterize the server's network behavior profile. A low proximity score combined with low resource utilization metrics may provide strong evidence that a server is idle, while a high proximity score may indicate that the server maintains operational relevance despite low local resource utilization. The proximity score may be incorporated into the multidimensional embedding as additional dimensions or may be used as a separate input feature to the classification model.

At step 308, it may be determined whether the server is an idle based on the assigned cluster from step 306. For example, clusters may be associated with information marking whether the particular cluster is associated with idle servers. The idle determination at step 308 may involve looking up the cluster label in a cluster metadata database that stores the idle/non-idle classification for each cluster established during training. The system may apply additional validation checks before confirming the idle classification, such as verifying that the server has exhibited consistent idle behavior over multiple consecutive observation periods rather than a single anomalous measurement. The determination may consider the confidence score from the random forest classifier, requiring higher confidence thresholds for servers that are critical to business operations or that have historically exhibited variable workload patterns. The system may implement a grace period before classifying a server as idle, requiring that the server remain in an idle cluster for a minimum duration (e.g., 24 hours or 7 days) to avoid premature classification of servers experiencing temporary low utilization. The idle determination may also consider external factors such as scheduled maintenance windows, planned batch processing jobs, or known seasonal variations in workload that may explain temporary periods of low activity.

At step 310, upon determining the server is an idle server, the server may be deactivated. This may further include updating a database to indicate that the server is an idle server. This may further include outputting one or more alerts to an external system that the server is an idle server. The deactivation process at step 310 may involve transmitting a shutdown command to the idle server over the network, instructing the server's operating system to perform a graceful shutdown that terminates running processes and releases allocated resources. The system may implement a staged deactivation process that first places the server in a standby state, allowing for rapid reactivation if the idle classification is determined to be incorrect, before proceeding to full shutdown. The database update may record the server identifier, the timestamp of idle classification, the assigned cluster, the confidence score, and the deactivation status in a centralized server inventory database. The alert output may transmit notifications to network management systems, ticketing systems, or administrator dashboards to inform relevant personnel of the idle server identification and deactivation action. The system may generate detailed reports summarizing the metric data, embedding analysis, and classification rationale that led to the idle determination, providing an audit trail for review and validation. The deactivation may trigger resource reallocation processes that redistribute computing resources previously assigned to the idle server, such as CPU cores, memory allocations, or network bandwidth reservations, to active servers within the data center environment to improve overall resource utilization efficiency. In some examples, the step 310 may be performed automatically in response to a server being determined to be idle.

In some aspects, deactivating the idle server may include transmitting a deactivation command to the idle server over a network to cause the idle server to shut down. This step may be performed automatically and without human intervention. Upon deactivation, computing resources previously assigned to the idle server may be reallocated to one or more active servers within the data center environment. This reallocation may improve overall data center efficiency by redistributing workloads and reducing energy consumption. The system may further transmit an alert to a network management system identifying the idle server for removal from an active server pool. By automatically detecting idle servers and taking proactive remedial actions including deactivation and resource reallocation, the system may provide an improvement to data center management technology that reduces energy waste and optimizes resource utilization.

In some aspects, the system may implement a network topology-aware pre-deactivation verification process to ensure that deactivating an idle server does not disrupt active communication dependencies within the data center environment. Upon receiving a determination that a target server is classified as idle, the system may retrieve the proximity scores and communication data associated with the target server from the vector database and communication logs. The system may analyze the communication data to determine whether any active servers maintain communication dependencies with the target server, such as servers that have transmitted packets to or received packets from the target server within a recent time window (e.g., the most recent 5 minutes, 15 minutes, or 1 hour). The dependency analysis may identify servers that rely on the target server for data exchange, service requests, or coordination messages, even if the target server exhibits low resource utilization metrics that would otherwise indicate idle status.

If communication dependencies exist between the target server and one or more active servers, the system may initiate a traffic rerouting process before proceeding with deactivation. The rerouting process may involve updating network routing tables, load balancer configurations, or service discovery registries to redirect network traffic from the target server to a designated replacement server that can assume the communication responsibilities. The system may verify that the rerouting is complete by monitoring network traffic to confirm that no active communication sessions remain with the target server, such as by checking that no new packets are addressed to the target server's IP address over a verification period. Upon confirming that all communication dependencies have been successfully rerouted and no active sessions remain, the system may transmit the deactivation command to the target server to initiate the shutdown process. Following deactivation, the system may reallocate computing resources previously assigned to the target server, including CPU cores, memory allocations, and network bandwidth reservations, to one or more active servers within the data center environment to improve overall resource utilization efficiency.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

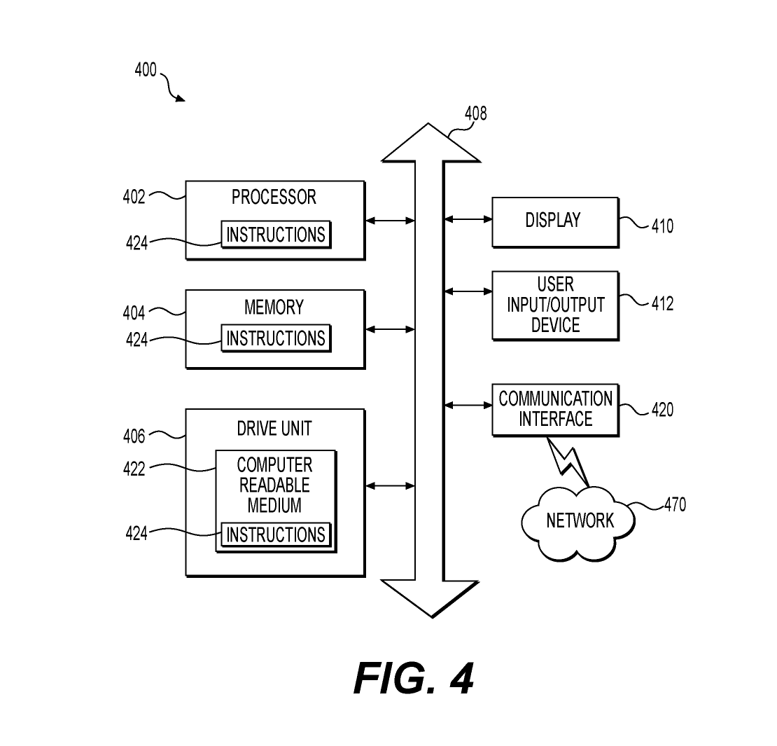

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 400 may further include a display unit 410, such as a liquid crystal display (LCD), an organic light emitting diode (OLED), a flat panel display, a solid-state display, a cathode ray tube (CRT), a projector, a printer or other now known or later developed display device for outputting determined information. The display unit 410 may act as an interface for the user to see the functioning of the processor 402, or specifically as an interface with the software stored in the memory 404 or in a disc or optical drive unit 406.

Additionally or alternatively, the computer system 400 may include an input/output device 412 configured to allow a user to interact with any of the components of the computer system 400. The input/output device 412 may be a number pad, a keyboard, or a cursor control device, such as a mouse, or a joystick, touch screen display, remote control, or any other device operative to interact with the computer system 400.

The disk or optical drive unit 406 may include a computer-readable medium 422 in which one or more sets of instructions 424, e.g., software, can be embedded. Further, the instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, a computer-readable medium 422 includes instructions 424 or receives and executes instructions 424 responsive to a propagated signal so that a device connected to a network 470 can communicate voice, video, audio, images, or any other data over the network 470. Further, the instructions 424 may be transmitted or received over the network 470 via a communication port or interface 420, and/or using a bus 408. The communication port or interface 420 may be a part of the processor 402 or may be a separate component. The communication port 420 may be created in software or may be a physical connection in hardware. The communication port 420 may be configured to connect with a network 470, external media, the display unit 410, or any other components in the computer system 400, or combinations thereof. The connection with the network 470 may be a physical connection, such as a wired Ethernet connection or may be established wirelessly as discussed below. Likewise, the additional connections with other components of the computer system 400 may be physical connections or may be established wirelessly. The network 470 may alternatively be directly connected to the bus 408.

While the computer-readable medium 422 is shown to be a single medium, the term "computer-readable medium" may include a single medium or multiple media, such as a centralized or distributed database, and/or associated caches and servers that store one or more sets of instructions. The term "computer-readable medium" may also include any medium that is capable of storing, encoding, or carrying a set of instructions for execution by a processor or that cause a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 400 may be connected to one or more networks 470. The network 470 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 470 may include wide area networks (WAN), such as the Internet, local area networks (LAN), campus area networks, metropolitan area networks, a direct connection such as through a Universal Serial Bus (USB) port, or any other networks that may allow for data communication. The network 470 may be configured to couple one computing device to another computing device to enable communication of data between the devices. The network 470 may generally be enabled to employ any form of machine-readable media for communicating information from one device to another. The network 470 may include communication methods by which information may travel between computing devices. The network 470 may be divided into sub-networks. The sub-networks may allow access to all of the other components connected thereto or the sub-networks may restrict access between the components. The network 470 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms "coupled" and "connected," along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. "Coupled" may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer implemented method for identifying an idle server, the method comprising:
receiving metric data from a server;
determining, by a first machine learning system, a multidimensional embedding that defines a signature of the server, the multidimensional embedding being based on the metric data;
applying, by a second machine learning system, a clustering algorithm to the multidimensional embedding to determine a first cluster from a set of clusters;
determining, based on the first cluster, that the server is an idle server; and
deactivating the idle server.

2. The method of claim 1,
wherein deactivating the idle server comprises:
transmitting a deactivation command to the idle server over a network to cause the idle server to shut down, and reallocating computing resources previously assigned to the idle server to one or more active servers within a data center environment.

3. The method of claim 1, further including:
receiving communication data between the server and one or more additional servers, the communication data being based on traceroute data of the server; and
defining a proximity score for the communication data, the proximity score being determined based upon the traceroute data, the proximity score defining a level of connection between the server and one or more additional servers.

4. The method of claim 3, wherein the multidimensional embedding is further based on the proximity score.

5. The method of claim 1, wherein the second machine learning system implements a random forest algorithm to determine the first cluster from the set of clusters.

6. The method of claim 1, wherein the clustering algorithm compares a distance of the multidimensional embedding with a set of multidimensional embeddings associated with the set of clusters.

7. The method of claim 1, further including:
upon determining the server is an idle server, updating a database to indicate that the server is a zombie server; and
transmitting an alert to a network management system identifying the idle server for removal from an active server pool.

8. A system for identifying an idle server, the system comprising:
a memory having processor-readable instructions stored therein; and
at least one processor configured to access the memory and execute the processor-readable instructions to perform operations including:
receiving metric data from a server;
determining, by a first machine learning system, a multidimensional embedding that defines a signature of the server, the multidimensional embedding being based on the metric data;
applying, by a second machine learning system, a clustering algorithm to the multidimensional embedding to determine a first cluster from a set of clusters;
determining, based on the first cluster, that the server is an idle server; and
deactivating the idle server.

9. The system of claim 8,
wherein deactivating the idle server comprises:
transmitting a deactivation command to the idle server over a network to cause the idle server to shut down, and reallocating computing resources previously assigned to the idle server to one or more active servers within a data center environment.

10. The system of claim 8, further including:
receiving communication data between the server and one or more additional servers, the communication data being based on traceroute data of the server; and
defining a proximity score for the communication data, the proximity score being determined based upon the traceroute data, the proximity score defining a level of connection between the server and one or more additional servers.

11. The system of claim 10, wherein the multidimensional embedding is further based on the proximity score.

12. The system of claim 8, wherein the second machine learning system implements a random forest algorithm to determine the first cluster from the set of clusters.

13. The system of claim 8, wherein the clustering algorithm compares a distance of the multidimensional embedding with a set of multidimensional embeddings associated with the set of clusters.

14. The system of claim 8, further including:
upon determining the server is an idle server, updating a database to indicate that the server is a zombie server; and
transmitting an alert to a network management system identifying the idle server for removal from an active server pool.

15. A non-transitory computer readable medium storing processor-readable instructions which, when executed by at least one processor, cause the at least one processor to perform operations including:
receiving metric data from a server;
determining, by a first machine learning system, a multidimensional embedding that defines a signature of the server, the multidimensional embedding being based on the metric data;
applying, by a second machine learning system, a clustering algorithm to the multidimensional embedding to determine a first cluster from a set of clusters;
determining, based on the first cluster, that the server is an idle server; and
deactivating the idle server.

16. The non-transitory computer readable medium of claim 15,
wherein deactivating the idle server comprises:
transmitting a deactivation command to the idle server over a network to cause the idle server to shut down, and reallocating computing resources previously assigned to the idle server to one or more active servers within a data center environment.

17. The non-transitory computer readable medium of claim 15, further including:
receiving communication data between the server and one or more additional servers, the communication data being based on traceroute data of the server; and
defining a proximity score for the communication data, the proximity score being determined based upon the traceroute data, the proximity score defining a level of connection between the server and one or more additional servers.

18. The non-transitory computer readable medium of claim 17, wherein the multidimensional embedding is further based on the proximity score.

19. The non-transitory computer readable medium of claim 15, wherein the second machine learning system implements a random forest algorithm to determine the first cluster from the set of clusters.

20. The non-transitory computer readable medium of claim 15, wherein the clustering algorithm compares a distance of the multidimensional embedding with a set of multidimensional embeddings associated with the set of clusters.
